(19) United States
(12) Patent Application Publication
(10) Pub. No.: US 2009/0020684 A1
(43) Pub. Date: Jan. 22, 2009

(54) Illumination apparatus and optical radiation control method thereof

(76) Inventors: Cheng-Chung Shih, Fremont, CA (US); Yuh-Min Lin, San Ramon, CA (US); Jia-Yang Koo, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/826,451

(22) Filed: Jul. 16, 2007

(51) Int. Cl. G01J 1/32

(52) U.S. Cl. 250/205

(57) ABSTRACT

The present invention discloses an illumination apparatus and an optical radiation control method. The illumination apparatus includes at least one light emitting module, an optical detector, a temperature calculating module and a control module. These emitting modules are for producing a light beam and the control module is for generating a PWM signal to drive the emitting modules. The optical detector electrically connected to the control module is for detecting the optical radiation of light emitted from the light modules. The temperature calculating module is for calculating the temperature of the illumination apparatus based on the PWM signal and a predetermined PWM width. The control module can adjust the optical radiation of light emitted from the light modules based on the temperature and the detected data of the optical detector.

### BACKGROUND OF THE INVENTION

1. Field of the Invention

The present invention relates to an illumination apparatus and an optical radiation control method thereof, and more particularly relates to an illumination apparatus with temperature compensatory function and an optical radiation control method thereof.

2. Description of the Related Art

Because of its power conservation, the LED is now being extensively used for optical display, for instance, traffic lights and tail lamps of motor vehicles. The white light used in lighting is also presently the focus of research on LED technology. Currently, white light is generated by a number of methods described below. One method is by placing the yellow phosphor powder on top of the blue LED. The yellow phosphor powder absorbs blue light and emits yellow light, and the white light can be generated by mixing the blue light and the yellow light. The shortcoming of this method is its short longevity because the yellow phosphor powder ages easily and causes attenuation of the yellow light, results in the phenomenon of color shift in the white light LED.

Another method is by mixing the red light LED, the green light LED and the blue light LED to generate white light. However, this method easily causes color shift because of the different conditions of each LED. U.S. Pat. No. 6,498,440 has presented a feedback mechanism to resolve this problem by utilizing an optical detector to detect the conditions of each LED and the detector will transmit a measurement result to a control circuit, and the control circuit uses the result to adjust the driving signal of the LED for rectifying the optical radiation of the LED.

Nevertheless, aside from the fact that aging of the LED affects optical radiation, temperature is also an important factor for changes in optical radiation. Referring to FIG. 4, the energy spectrum distributions of the LED in degree.40 C. and degree.70 C. shows substantial variation with the same driving signal. When temperature rises, the LED optical radiation drops and the wavelength shifts. A drop in optical radiation can be compensated by the aforementioned feedback mechanism, but shift in wavelength cannot possibly be compensated with the feedback mechanism, rather this phenomenon can cause erroneous adjustment of the feedback mechanism. Furthermore, the aging of LED is a slow process and the effect from aging can be effectively compensated with the aforementioned feedback mechanism. But the surrounding temperature of the LED changes frequently with weather and operation of LED, compensation by the feedback mechanism alone is insufficient.

In view of the various problems in conventional art, the inventor of the present invention with years of research and development and experience in the industry, has presented an illumination apparatus and an optical radiation control method for overcoming the above shortcomings.

### SUMMARY OF THE INVENTION

The purpose of the present invention is to provide an illumination apparatus and an optical radiation control method to offset effect to the illumination apparatus from temperature changes.

In accordance with the purpose of this invention, the illumination apparatus presented comprises at least one light emitting module, one control module, one optical detector module and a temperature calculating module. The light emitting module is for producing a light beam, and the control module is for generating a PWM signal to drive the emitting module. The optical detector electrically connected to the control module is for detecting the optical radiation of light emitted from the light module. The temperature calculating module electrically connected to the control module is for calculating the temperature of the light module based on the PWM signal and a predetermined PWM width. The control module can adjust the optical radiation of light emitted from the light module based on the temperature and the detected data of the optical detector.

Moreover, the present invention also presents an optical radiation control method for use in the illumination apparatus, wherein the illumination apparatus has at least one light emitting module and the method includes following steps of: using at least one PWM signal to drive the emitting module; calculating the temperature of the emitting module in accordance with the PWM signal and a predetermined PWM width; detecting the optical radiation of the emitting module; and adjusting the optical radiation of the emitting modules in accordance with the detected optical radiation data and the calculated temperature.

To make it easier for our examiner to understand the above technology and the effect achieved, the following feasible preferred embodiment accompanied with the related drawings are described in details.

### BRIEF DESCRIPTION OF THE DRAWINGS

FIG. 1 is a block diagram showing the illumination apparatus of the present invention;

FIG. 2 is a block diagram of a preferred embodiment of the illumination apparatus of the present invention;

FIG. 3 is a flow chart of the steps for the optical radiation control method of the illumination apparatus of the present invention; and

FIG. 4 is a chart recording the temperature changes corresponding to the LED emitted light wavelength and power.

### DETAILED DESCRIPTION OF THE PREFERRED EMBODIMENT

The relevant charts and diagrams below describe a preferred embodiment of the present invention for an illumination apparatus and an optical radiation control method. For helping better understand same symbols are used to indicate the same elements in the embodiment.

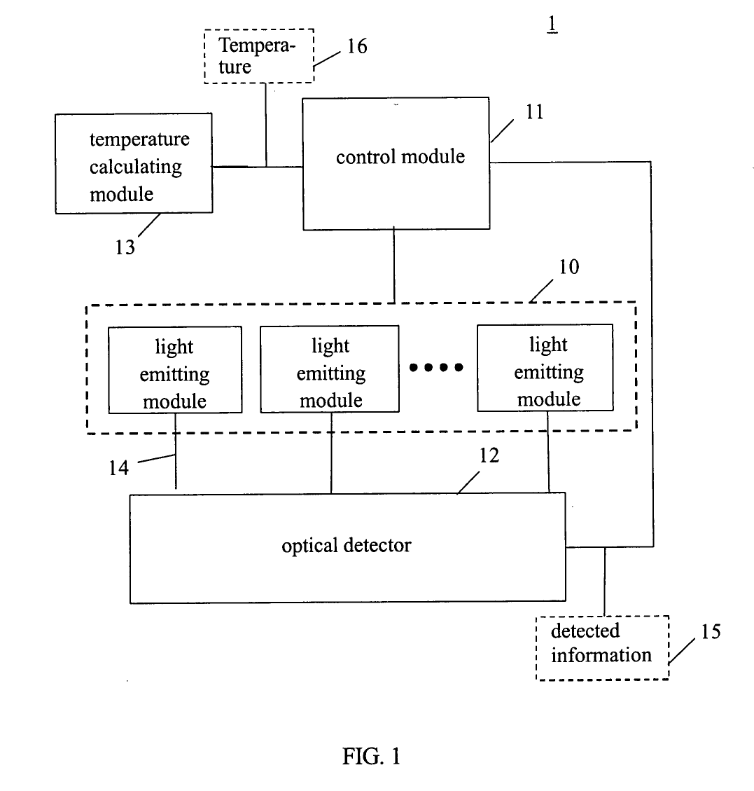

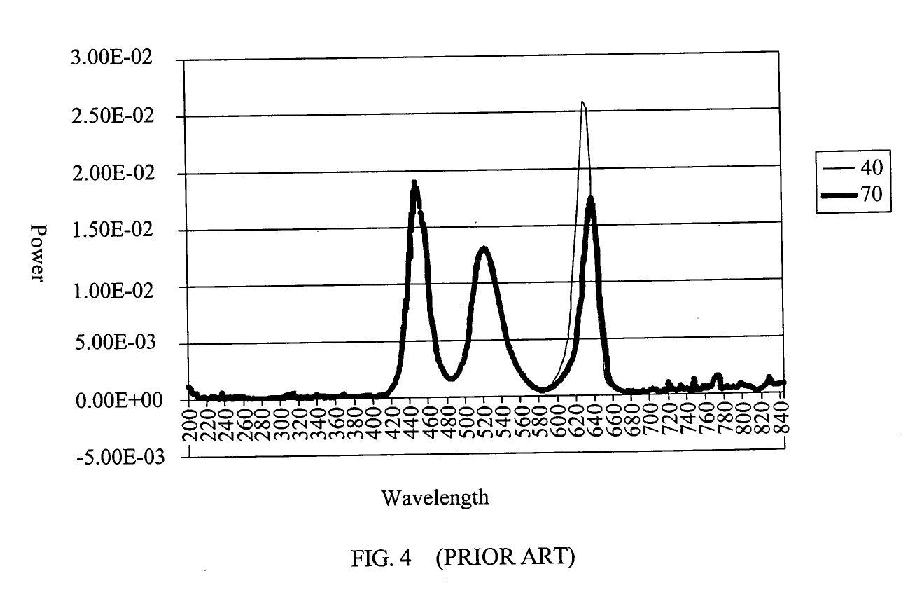

Referring to the block diagram of the illumination apparatus of the present invention as shown in FIG. 1, the illumination apparatus 1 comprises at least one light emitting module 10, a control module 11, at least one optical detector 12 and a temperature calculating module 13. The light emitting module 10 is for emitting a light beam 14. For instance, the light emitting module 10 may be a red light LED, a green light LED and a blue light LED. If the illumination apparatus comprises these three types of LEDs, the illumination apparatus can emit tri-color light to mix into lights of different colors. The control module 11 is for generating a PWM signal to drive the light emitting module 10. The optical detector 12 electrically connected to the control module 11 is for detecting the optical radiation 14 of light emitted from the light modules 10. The temperature calculating module 13 electrically connected to the control module 11 is for calculating the temperature of the light emitting module 10 based on the PWM signal and a predetermined PWM width. The control module 11 can adjust the optical radiation 14 of light emitted from the light modules 10 based on the temperature 16 and the detected data 15 from the optical detector 12.

Wherein the aging of the LED is comparatively slow, if major change of optical radiation is detected in a short period of time it is usually caused by temperature changes of the light emitting module. Hence, a PWM width corresponding to a specific temperature of the light emitting module can be predetermined first, and the temperature of the light emitting module is calculated based on the difference between the PWM signal and the predetermined PWM width. For instance, as FIG. 4 shows, when temperature rises to degree.70 C. the optical radiation of the light emitted by the LED would decline and red color shift would occur because of increase of the light wavelength. Thereby, the optical radiation detected by the optical detector 12 would decrease, and the control module 11 would increase the length of the PWM signal for maintaining a stable optical radiation of the light emitted by the LED. To compensate for the wavelength shift caused by increase in temperature, the temperature calculating module 13 must first calculate the temperature of the LED and refer to a look-up table which records the corresponding relationship among the temperature, light wavelength, optical radiation and PWM signal, and allow the control module 11 to generate the most optimum PWM signal. The temperature and the PWM signal width are in a linear or nonlinear proportional relation.

For example, the optical radiation and wavelength of the light emitted by the LED corresponding to temperature changes are detected in advance. Likewise, when temperature rises from degree.40 C. to degree.70 C., the detected red light LED light power drops from 2.60E-02 to 1.75E-02; and in accordance with the aforementioned feedback mechanism, the control module 11 would increase the PWM_R width of the PWM signal which is used to drive red light LED for enhancing the light power of the red light LED. Thus, the corresponding relation between the temperature and the duty cycle of the PWM signal can be estimated.

Temperature=Parameter A×(PWM_{—}R−Predetermined PWM width)

Wherein the predetermined PWM width is related to the light color desired to maintain by the illumination apparatus. Furthermore, when the detected temperature rises from degree.40 C. to degree.70 C., the emitted light wavelength from the red light LED increases 4 nm; therefore, the compensatory parameter can be estimated in advance and be recorded on the look-up table.

The optical detector may be a silicon photodiode or a CdS photoresistor, and the control module 11 may comprise a signal processing unit, a PWM signal generator and at least one transistor that is electrically connected to the light module. The signal processing unit is for performing a computation based on the detected data 15 and the temperature 16, and using the computed result to control the PWM signal generated by the PWM signal generator, thereby enabling the light module to emit the desired light.

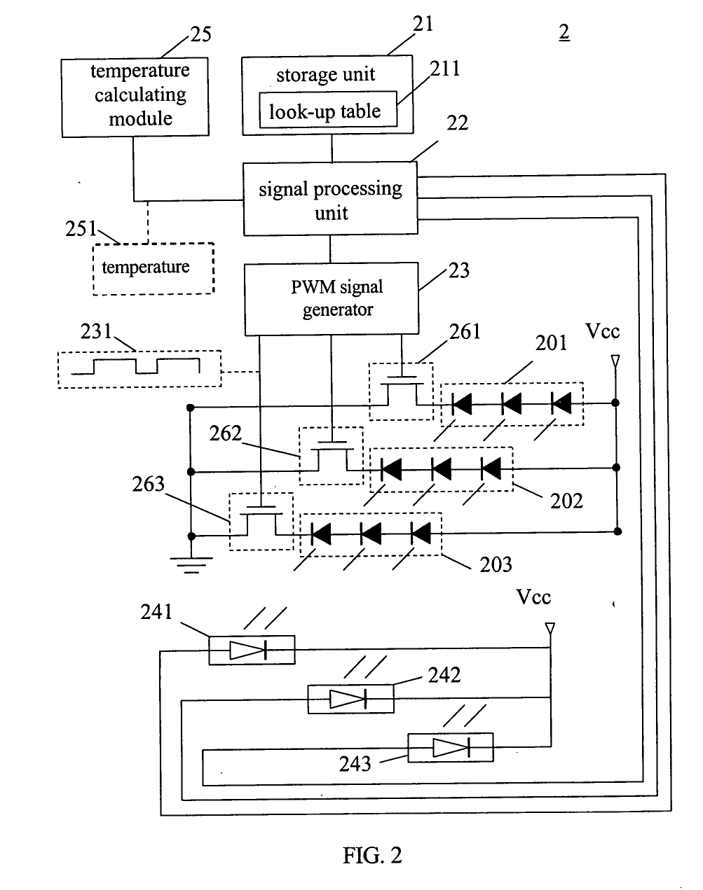

Referring to the block diagram of the preferred embodiment of the present invention as shown in FIG. 2, the illumination apparatus 2 comprises a plurality of red light LED 201, a plurality of green light LED 202 and a plurality of blue light LED 203, a storage unit 21, an optical detecting module 241 for detecting the red light, an optical detecting module 242 for detecting the green light, an optical detecting module 243 for detecting the blue light, a temperature calculating module 25 and a plurality of transistors 262, 262 and 263. The storage unit 21 stores a look-up table 211 showing records the corresponding relation among the temperature, light wavelength, optical radiation and the driving signal.

The gate of the transistors 261, 262 and 263 is electrically connected to the PWM signal generator 23, and its drain is electrically connected to negative end of the red light LED 241, the green light LED 242 and the blue light LED 243 respectively and its source is grounded. The gate of the transistors 262, 262 and 263 respectively receives the PWM signal generated by the PWM signal generator 23, and the PWM signal includes a pert of high voltage and a part of low voltage part, and when high voltage is received, the transistors would enter the open status and form a pass circuit enabling electric current flowing to the LED to emit light. When low voltage is received, the transistors would enter the close status and form a break circuit and the LED stops to emit light. Therefore, the optical radiation of the LED can be adjusted by changing the width of the high voltage part of the PWM signal or by changing the proportion of high voltage part and low voltage part.

The optical detecting modules 241, 242 and 243 respectively comprise a light filter and a silicon photodiode, and the light filter of the optical detecting modules 241, 242 and 243 filters the red light (wavelength 620 nm˜660 nm), the green light (wavelength 510 nm˜550 nm) and the blue light (wavelength 440 nm˜470 nm) respectively, so that the silicon photodiode of the optical detecting modules 241, 242 and 243 can detect the optical radiation of the red light, the green light and the blue light separately, and transmit the detected data to the signal processing unit 22. The signal processing unit 22 controls the PWM signal generator 23 to adjust its output PWM signal based on the detected data. For example, if the red light LED 241 ages and makes the silicon photodiode 241 detect a lower red light optical radiation, and the signal processing unit 22 judges that the red light optical radiation signal is lower than the predetermined value, the signal processing unit 22 then controls the PWM signal generator 23 to increase the high voltage part of the transistor 201 PWM signal in order to drive the red light LED 241 to emit stronger light until the silicon photodiode 241 detects that the red light optical radiation restores to its predetermined value. Thus, by using aforementioned feedback mechanism to control the LED and enable the illumination apparatus 2 to emit consistently a predetermined light.

The temperature calculating module 25 is electrically connected to the signal processing unit 22 and transmits the calculated temperature 251 to the signal processing unit 22. The signal processing unit 22 accesses the look-up table stored in the storage unit 21 and uses the recorded data of the look-up table to control the PWM signal generator to adjust its output PWM signal.

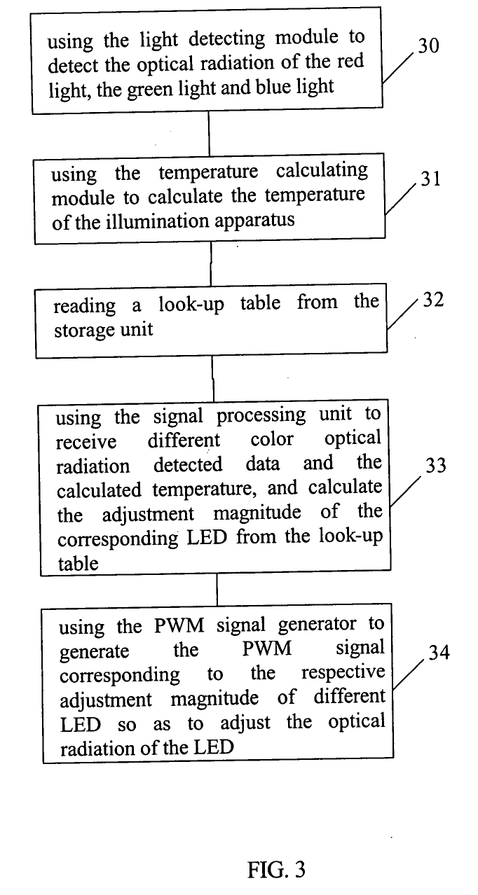

FIG. 3 is a flow chart showing the steps for the optical radiation control method of the invention. This method corresponds to the illumination apparatus 2 as shown in FIG. 2. The method includes the following steps:

Step 30: Use the optical detecting modules 241, 242 and 243 to detect the optical radiation of the red light, the green light and the blue light;

Step 31: Using the temperature calculating module 25 to calculate the temperature of the illumination apparatus 2;

Step 32: Using the signal processing unit 22 to read the look-up table 211 from the storage unit 21;

Step 33: Using the signal processing unit 22 to receive the detected red light optical radiation, the green light optical radiation, the blue light optical radiation and the detected temperature data 251, and compute the corresponding adjustment magnitude of the red light LED 201, the green light LED 202 and the blue light LED 203 according to the look-up table 211; and

Step 34: The PWM signal generator 23 generates the PWM signal corresponding to the adjustment magnitude of the LED for adjusting the LED optical radiation.

While the invention has been described by way of example and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An illumination apparatus comprising:
at least one light emitting module for producing a light beam;
a control module for generating a PWM signal to drive the emitting modules;
at least one optical detecting module electrically connected to the control module for detecting the optical radiation of the light beam; and
a temperature calculating module electrically connected to the control module, and the temperature calculating module is for calculating the temperature of the light module based on the PWM signal and the predetermined PWM width;
wherein the control module adjusts the optical radiation of the light beam emitted by the light module based on the detected data and temperature of the optical radiation;

2. The illumination apparatus as recited in claim 1, wherein the light emitting module is an LED.

3. The illumination apparatus as recited in claim 1, wherein the light module comprises a red light LED, a green light LED and a blue light LED.

4. The illumination apparatus as recited in claim 1, wherein the control module comprises a signal processing unit, a PWM signal generator and at least one transistor electrically connected to the light module, and the signal processing unit performs a computation based on the detected optical radiation data and temperature, and controls the PWM signal generator to produce the PWM signal according to the computed result, and enables the light module to emit the desired light.

5. The illumination apparatus as recited in claim 1, wherein the control module comprises a storage unit which stores a look-up table, and the look-up table records the corresponding relations of the temperature, light wavelength, optical radiation and driving signal.

6. The illumination apparatus as recited in claim 1, wherein the light detecting module comprises a silicon photodiode or a CdS photoresistor.

7. The illumination apparatus as recited in claim 1, wherein the light detecting module comprises a filter.

8. An optical radiation control method applicable to an illumination apparatus and the illumination apparatus has at least one light module, and the method comprising following steps of:
using at least one PWM signal to drive the emitting module;
calculating the temperature of the light module based on the PWM signal and the predetermined PWM width;
detecting the optical radiation of the light emitted by the emitting module;
adjusting the optical radiation of the light emitted by the emitting module based on the detected data of the optical radiation and the calculated temperature.

9. The optical radiation control method as recited in claim 8, wherein the light emitting module is an LED.

10. The optical radiation control method as recited in claim 8, wherein the light emitting module comprises a red light LED, a green light LED and a blue light LED.

11. The optical radiation control method as recited in claim 8, wherein the control module comprises a signal processing unit, a PWM signal generator and a plurality of transistors each electrically connected to one of the light modules, and the signal processing unit performs a computation based on the detected optical radiation data and the detected temperature, and controls generation of the PWM signal by the PWM signal generator based on the computed result and enables the light module to emit the desired light.

12. The optical radiation control method as recited in claim 8, further comprising a step of providing a look-up table, and searching in the look-up table based on the detected temperature data to obtain a driving signal, wherein the look-up table records the corresponding relations of temperature, light wavelength, optical radiation and driving signal.

13. The optical radiation control method as recited in claim 8, wherein a light detecting module comprises a silicon photodiode or a CdS photoresistor.

14. The optical radiation control method as recited in claim 8, wherein the light detecting module comprises a filter.
